(19) United States
(12) Patent Application Publication
(10) Pub. No.: US 2014/0019206 A1
(43) Pub. Date: Jan. 16, 2014

(54) PREDICTIVE CONFIDENCE DETERMINATION FOR SALES FORECASTING

(71) Applicants: Stefan Kraus, Bruchsal (DE); Ruediger Eichin, Heidelberg (DE)

(72) Inventors: Stefan Kraus, Bruchsal (DE); Ruediger Eichin, Heidelberg (DE)

(73) Assignee: SAP AG, Walldorf (DE)

(21) Appl. No.: 13/546,357

(22) Filed: Jul. 11, 2012

(51) Int. Cl. G06Q 10/04

(52) U.S. Cl. 705/7.31

(57) ABSTRACT

A system and method provide for identifying relevant success drivers from previous historical sales data and separating sales data into successful and unsuccessful business segments by generating predictive confidence determinations. After the successful and unsuccessful business segments have been identified, the business segments may be classified into determined confidence categories or levels. Each opportunity in an opportunity pipeline is assigned to a specific business segment and corresponding confidence level. A simulation of the sales forecasting system displays an opportunity pipeline broken done into confidence levels for each of the opportunities.

### BACKGROUND INFORMATION

Sales forecasting in the professional service industry is mostly based on opportunity management. The related business and opportunity data typically reflect the subjective expectations of the sales team. Sales managers, who need to rely on a consolidated forecast based on those estimates, need to evaluate any expectations based on reality and success factors which have driven the business in the past. There remains a need, currently unfulfilled by current sales projections systems, to evaluate the confidence and reliability of the committed sales forecast with a systematic and predictive method.

Existing implementations such as decision trees models or logic models are often overly convoluted because an analysis requires a particular field of expertise or a lot of expert knowledge. These implementations are overly complex and are not transparent, which makes them undesirable to an end user such as a sales manager.

Thus, there remains a need in the art for a predictive method that extracts learning principles from previous successful sales business and applies these principles to the current sales or opportunity pipeline. There also remains a need in the art for a system to generate confidence and reliability information about a committed sales forecast with a systematic and predictive method.

### SUMMARY

A system and method are described herein that provide for identifying relevant success drivers from previous historical sales data in a sales forecasting application and separating sales data into successful and unsuccessful business segments by generating predictive confidence determinations. After the successful and unsuccessful business segments have been identified, the business segments may be classified into determined confidence categories or levels. Each opportunity in an opportunity pipeline is assigned to a specific business segment and corresponding confidence level. A simulation of the sales forecasting system displays an opportunity pipeline broken done into confidence levels for each of the opportunities.

In particular, the exemplary embodiments and/or exemplary methods are directed to a system and method for providing predictive confidence determination for opportunities in sales forecasts. The system and method include at least one user terminal displaying a user interface, with the sales forecasting system displayed on the user interface. An in-memory database is also included. The database may store historical data and opportunity data.

The sales forecasting application can be executed by a processor to identify business segments correlated to at least one selected influencing attribute. The business segments may further be evaluated to identify any trends which may be used to predict outcomes for sales revenue for the business segments. The predicted sales revenue outcomes may be used to assign confidence levels to each of the business segments. The confidence levels may be divided by boundary values between each of the confidence levels that are selectably controlled.

The business segments may be sorted in descending order based on the assigned confidence level. Business segments having predicted outcomes greater than a first boundary value may be determined as having a high confidence level. Business segments having predicted outcomes lower than a second boundary value may be determined as having a low confidence level. Subsequently, business segments having predicted outcomes between the first and the second boundary values may be determined as having a medium confidence level.

Each opportunity from the opportunity data may be mapped to one of the business segments and the confidence level of the business segment can also assigned to the mapped opportunity. An opportunity pipeline can be displayed in the forecasting application in the user interface of the user terminal. The opportunity pipeline can be separated into various areas corresponding to the confidence levels for the opportunities.

An advanced business application programming (ABAP) system may also be used access the stored historical and opportunity data from the in-memory database if needed. The sales forecasting system may be implemented on an integrated business platform.

### BRIEF DESCRIPTION OF THE DRAWINGS

FIG. 1 is a diagram of a sales forecasting application displayed on a user terminal according to an embodiment.

FIG. 2 is a diagram of the architecture of a sales forecasting system according to an embodiment.

FIG. 3 is a diagram of an analysis stage in the sales forecasting application for predicting confidence categories for specific business segments as displayed on a user interface according to an embodiment.

FIG. 4 is a diagram of an analysis of the opportunity pipeline in the sales forecasting application segmented into various predictive confidence categories as displayed on a user interface according to an embodiment.

### DETAILED DESCRIPTION

The subject matter will now be described in detail for specific preferred embodiments, it being understood that these embodiments are intended only as illustrative examples and is not to be limited thereto these embodiments.

Previous implementations that provided sales forecasts and projections provide general analysis and do not provide predictive and reliability information pertaining to each opportunity. Embodiments provide a system and method for an interactive sales forecasting system that identifies relevant success drivers from the previous historical sales data and separates sales data into successful and unsuccessful business segments. After the successful and unsuccessful business segments have been identified, the business segments may be classified into determined confidence categories or levels. Each opportunity in an opportunity pipeline is assigned to a specific business segment and corresponding confidence level. A simulation of the sales forecasting system displays an opportunity pipeline broken done into confidence levels for each of the opportunities.

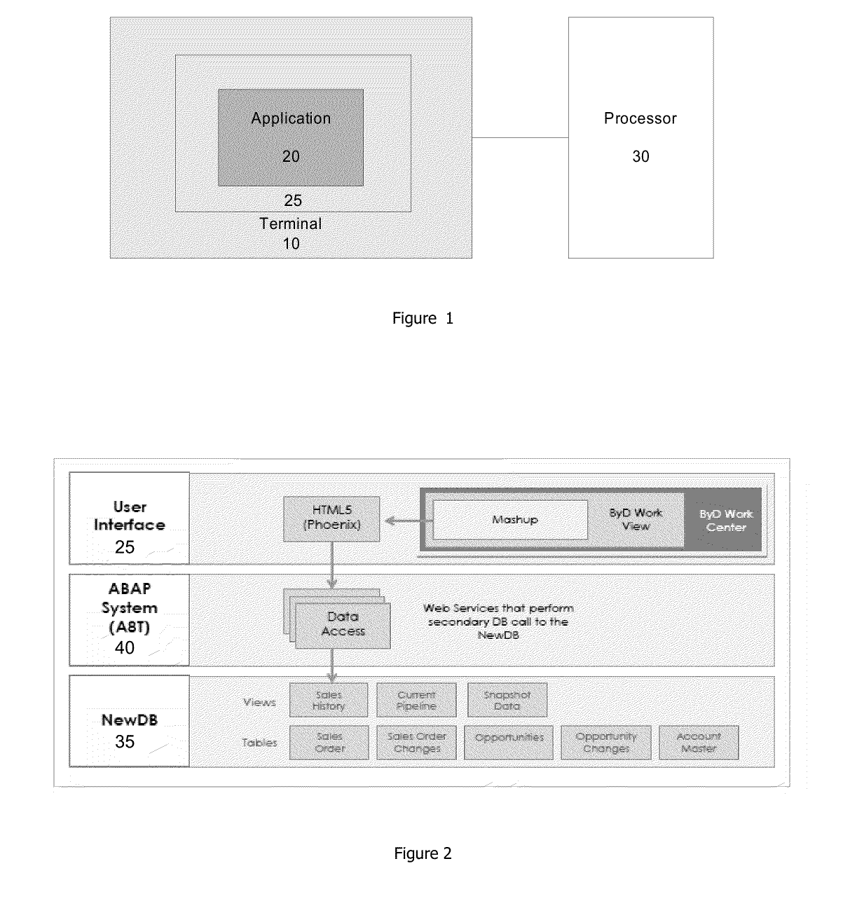

FIG. 1 illustrates a diagram of a user terminal 10 displaying the sales forecasting application 20 on the terminal. Application 20 may be executed, for example, by a processor 30 and may be displayed on a user interface 25 of user terminal 10 to a user. In an embodiment, application 20 may be provided on an integrated business platform and stored in a main memory database of a computing device. In an embodiment, the integrated business platform may be SAP Business ByDesign™. User terminal 10 may be embodied, for example, as a desktop, laptop, notebook, or other computing device. In other embodiments, user terminal 10 may be a hand-held device, personal digital assistant (PDA), television set-top Internet appliance, mobile telephone, smart phone, iPod™, iPhone™, iPad™, etc., or as a combination of one or more thereof, or other comparable device.

In an example embodiment, application 20 may be an application that is implemented on a back end component and displayed on a user interface on user terminal 10. In another embodiment, the application may be a computer-based application stored in the main memory database of user terminal 10.

In an example embodiment, the system and method may include one or more processors 30, which may be implemented using any conventional processing circuit and device or combination thereof, e.g., a central processing unit (CPU) of a personal computer (PC) or other workstation processor, to execute code provided, to perform any of the methods described herein, alone or in combination. In an embodiment, the executed code may be stored in a main memory database of user terminal 10. In this example embodiment, the main memory database may be an in-memory database such as SAP HANA™, where data is stored in the main memory (RAM).

FIG. 2 illustrates a diagram of the architecture of the sales forecasting application and system according to an embodiment. In an embodiment, the sales forecasting system may be viewed on a user terminal 10 and communicate with a back end system. In the architecture depicted in FIG. 2, the sales forecasting system may include a database 35. In an embodiment, database 35 may be an in-memory database. Database 35 may be loaded with, and subsequently store, data such as customer data, sales orders, change data, opportunity data, and any master data. Data may be extracted from a plurality of productive systems and pushed into database 35. Examples of relevant data that may be stored in database 35 may include, as depicted in FIG. 2, “Sales Orders” “Sales Order Changes” “Opportunities”, “Opportunity Changes”, and “Account Master”. This data may be presented in tables, for example, to be retrieved from database 35. In an example embodiment, this data may be modeled through HANA modeling using HANA Studio™ and uploaded to database 35 via a file transfer.

Database 35 may also include data, for example, pertaining to “Sales History”, “Current Pipeline”, and “Snapshot Data”, which may provide data that may be viewed in a graphical manner by an end user. It should be understood that the examples of stored data as illustrated in FIG. 2 does not represent an exhaustive list of all data that may be stored in database 35.

The sales forecasting application 20 may be displayed on an a user interface 25. User interface 25 may be designed specifically to provide an interaction flow to allow for combining the analytics on the retrieved data with visualizations derived from the retrieved data. In an embodiment, user interface 25 may be configured to display the integrated business platform such as SAP Business ByDesign™. The layout of the user interface 25 may be written in a plurality of programming languages. In an example embodiment, as illustrated in FIG. 2, an html language such as html5 may be used to design the user interface 25.

In an embodiment, data may be directly accessed from database 35 by the application. In another embodiment, the data from database 35 may be accessed using an advanced business application programming (ABAP) system 40. ABAP system 40 may be a web-based service defined in an Internet communication frame work and may issue a secondary database call to database 35 to access the stored data.

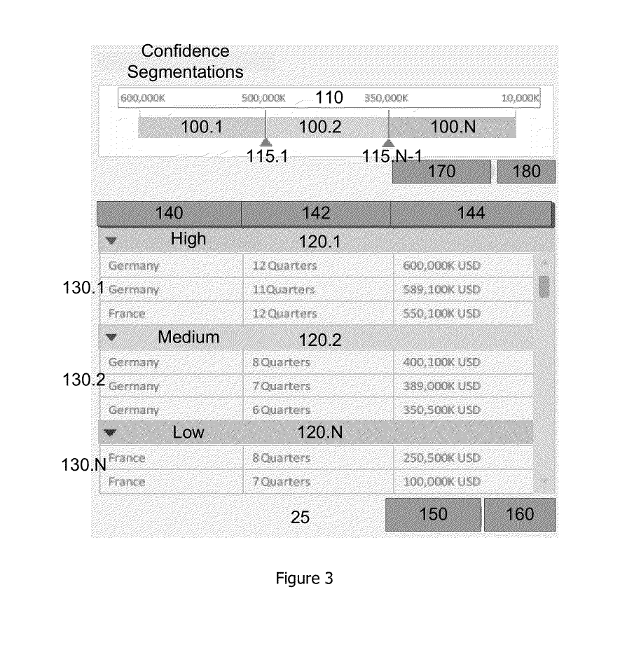

FIG. 3 is a diagram of a stage in the sales forecasting application for predicting confidence categories for specific business segments as displayed on a user interface 25 according to an embodiment. The sales forecasting application 20 may analyze the historical data stored in database 35 using predictive and statistical methods to determine influencing attributes for success sales orders. The manner in which this occurs may be described further in co-pending U.S. patent application Ser. No. 13/546,157.

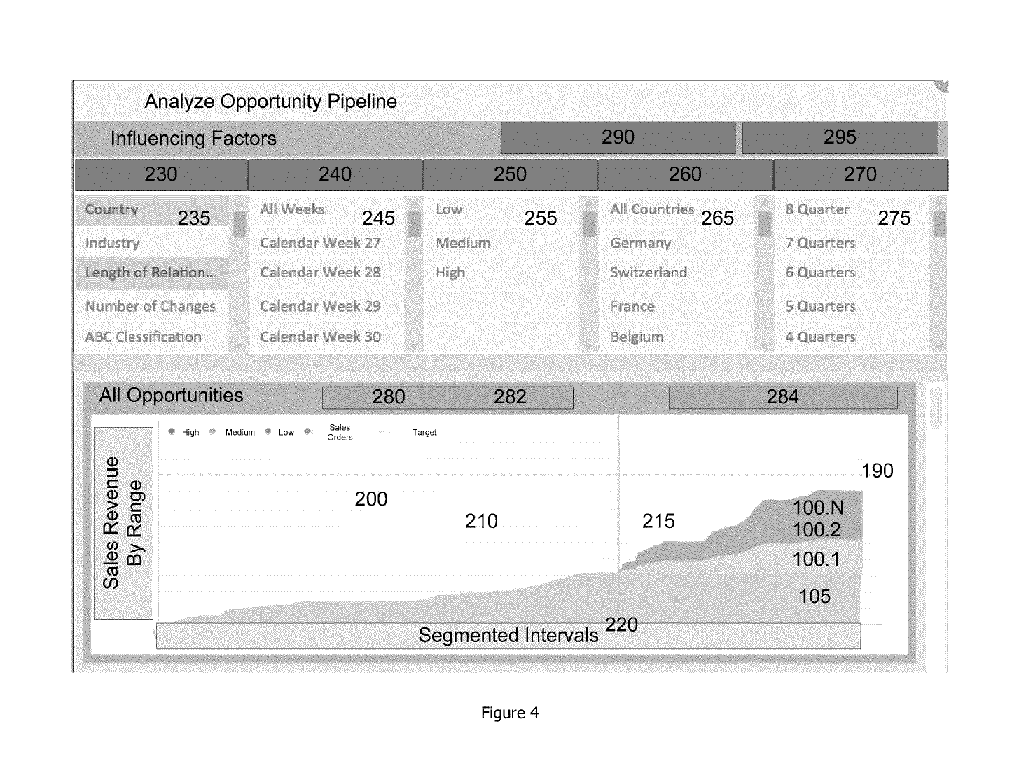

An end user may be presented with a list of various influencing attributes sorted by relevance. These may be presented, for example, as depicted in FIG. 4, by panel 230 and selection field 235. Selection field 235 may list various influencing attributes that may be sorted according to their relevance. In an embodiment, influencing attributes may be listed in an order in accordance to a determination for the attributes as success drivers. A user may select one or more of the listed attributes in order to view the corresponding segmentation information that is to be determined for the attribute(s). One manner in which a user may view the confidence segmentations window as illustrated is by the selection of clickable button 290, which, in an embodiment, may allow the user to view the confidence segmentations window of FIG. 3.

FIG. 3 illustrates a viewing pane of the user interface 25 corresponding to confidence segmentation for the influencing attributes. In an embodiment, the viewing pane may be opened in a separate window from any existing window of the sales forecasting application 20. In another embodiment, the viewing pane corresponding to confidence segmentation information may be integrated into another existing window of the sales forecasting application 20. The confidence segmentations information in the viewing pane may be used to allow for the classification of the listed business segmentations across a specified number of confidence categories. The most relevant influencing attributes may be previously determined by the system and presented to a user.

An end user may be informed of the most successful attributes to identify successful business segments. These attributes may be selected by the end user, for example, a selection of the influencing attributes “Country” and “Length of Relationship” may be done by a user, as depicted in FIG. 4, to identify the most successful business segments pertaining to these attributes. The corresponding business segments may represent various combinations of the selected influencing attributes and may be generated and identified based on an evaluation of the historical sales data pertaining to the selected influencing attributes. The business segments may be listed in tables 130.1-130.N in accordance to a determined confidence level for the respective business segment.

Panels 140 and 142 in the viewing pane may list the selected influencing attributes for the business segments listed in the confidence tables below. Panel 140 may correspond to a first selected influencing attribute, with an attribute value corresponding to the first selected influencing attribute being displayed in a first column in the tables 130.1-130.N displayed below. In the example embodiment in FIG. 3, where “Country” is designated as a first influencing attribute, tables 130.1, 130.2, and 130.N may display a corresponding country value in the columns of the listed business segments. Panel 142 may correspond to a second selected influencing attribute, with an attribute value corresponding to the second selected influencing attribute being displayed in a second column in the tables 130.1-130.N displayed below. In the example embodiment in FIG. 3, where “Length of Relationship” is designated as a second influencing attribute, tables 130.1, 130.2, and 130.N may display a corresponding time period value in the columns of the listed business segments.

The business segments may be evaluated to discern if any of segments may follow a particular trend. In an embodiment, any identified trend may be extrapolated to predict the expected revenue for the particular segment. In other embodiments, the identified trends may be used to predict outcomes for other key figures, such as total sales, etc.

Before confidence categories may be calculated for each business segment, the number of confidence categories that an end user wants to achieve may be set and selectably controlled by an end user. In an embodiment, a user may, for example, change the number of desired confidence categories in the settings of the sales forecasting application by clicking on button 180. A user may also define a revenue percentage he wants to assign to each confidence category in the settings by clicking on button 180. As a result of these steps, the business segments may be separated and classified into confidence categories, which group the business into more and less successful areas.

In the example embodiment of FIG. 3, a designation may be made for three confidence categories or levels. In other embodiments, a designation may be made for more or less confidence categories. In the example embodiment where three confidence categories may be selected, these levels may correspond to, for example, “High”, “Medium, and “Low”. The designation for these levels may be adapted based on the number of confidence categories that have been chosen. In the example embodiment in FIG. 3, panel 120.1 may display business segments that may have a determined confidence level of “High”. These business segments may be arranged in descending order in table 130.1. Panel 120.2 may display business segments that may have a determined confidence level of “Medium” and these business segments may be arranged in descending order in table 130.2. Panel 120.N may display business segments that may have a determined confidence level of “Low” and these business segments may be arranged in descending order in table 130.N.

Classification of the business segments into the confidence categories may be done by sorting the list of business segments according to a selected key statistic. In an embodiment, this statistic may correspond to revenue, as illustrated in FIG. 3. In this embodiment, expected revenues for all combinations of the business segments listed in tables 130.1-130.N may be calculated. Panel 144 may correspond to the expected revenue of each particular business segment. In other embodiments, panel 144 may correspond to an expected value for another key statistic.

In the embodiment in FIG. 3, a revenue value may be displayed in the third column in the tables 130.1-130.N displayed below panel 144, where each value corresponds to an expected revenue of the corresponding business segment based on any identifiable trends. The business segments may be arranged in confidence tables 130.1-130.N based on a sorting of the segments according to predicted revenues, which results in a sorted list of all segments from successful to unsuccessful ones. In other embodiments where another statistic is selected, sorting may occur in accordance with that statistic. The confidence categories may be applied to the sorted business segments based on the designated number of confidence categories.

The boundaries of the confidence categories for the designated number of levels may be set by confidence bar areas 100.1-100.N and value spectrum 110. Value spectrum 110 may correspond to a range of values for the key statistic that encompasses each of the business segments. In the example embodiment depicted in FIG. 3, the sorting statistic may be determined to be predicted revenue in panel 144. Value spectrum 110 may correspond to a range of values that encompass the predicted revenue for each of the business segments. In an embodiment, value spectrum 110 may be situated at the top of the viewing pane and above the corresponding business segments. A confidence bar may be situated below value spectrum 110. The confidence bar may be divided into various confidence levels, in accordance with a designated number of desired levels. In the embodiment in FIG. 3, where a user may designate three confidence levels, the confidence bar may be divided into three confidence bar areas, with each confidence bar area corresponding to a separate confidence level.

In an embodiment, confidence bar area 100.1 may correspond to a “High” confidence level, confidence bar area 100.2 may correspond to a “Medium” confidence level, and confidence bar area 100.N may correspond to a “Low” confidence level. The confidence bar areas 100.1-100.N may together span the entire value spectrum 110. The boundaries between the respective confidence bar areas may be set by selecting icons 115.1 and 115.N−1. In an embodiment where a user may designate more confidence levels, additional selecting icons may be used to separate the confidence bar into additional confidence bar areas. In an embodiment where a user designates only two confidence levels, only one selecting icon may be used to separate the confidence bar areas. In the example embodiment of FIG. 3, selecting icon 115.1 may be dragged across the value spectrum 110 to set the boundary between confidence bar area 100.1 and confidence bar area 100.2. In this embodiment, any of the business segments having an expected value that is at or above the value set by selecting icon 115.1 may be determined to have a high confidence level and may be displayed in table 130.1.

Similarly, a selecting icon 115.N−1 may be dragged across the value spectrum 110 to set a lower boundary between confidence bar area 100.2 and confidence bar area 100.N. In this embodiment, any of the business segments having an expected value that is below the value set by selecting icon 115.N−1 may be determined to have a low confidence level and may be displayed in table 130.N. Business segments having expected values that fall between the boundaries set by icons 115.1 and 115.N−1 may be determined to be medium confidence level business segments and may be displayed in table 130.2. Selecting clickable button 150 may allow for the system to apply the changes made by selecting icon 115.1 and 115.2, which may classify the business segments into the respective confidence levels. A user may choose to undo any segmentation by selecting clickable button 170. A user may also close the confidence segmentations viewing window selecting clickable button 160.

FIG. 4 illustrates a diagram of the sales forecasting application 20 including segmenting an opportunity pipeline into various confidence levels as displayed on user interface 25 according to an embodiment. As depicted in FIG. 4, an opportunity analysis may be displayed on a viewing pane in user interface 25 to an end user. The viewing pane in user interface 25 may include a graphical display 200 which may depict completed sales orders along with an opportunity pipeline which may reflect potential future sales opportunities. The displayed opportunity pipeline for future sales may be divided into distinct confidence levels for each opportunity.

The y-axis of graphical display 200 may correspond to a key statistic, for example, a range of sales orders by units or total sales revenue. The x-axis of graphical display 200 may correspond to selected time intervals over a designated period of time. In an embodiment, each unit on the x-axis of graphical display 200 may correspond to a subsequent sales week or quarter.

The graphical display 200 in the viewing pane of the user interface 25 may be made up of multiple areas. A first area 210 may correspond to historical data, particularly historical sales data such as completed sales orders. The sales orders at specific time periods over a designated period of time may be presented in graphical display 200. This information may be plotted graphically, as an area 105 displayed in graphical display 200. In an embodiment, the first area 210 may correspond to sales data before a designated date 220. In an embodiment, date 220 may correspond to a present week or quarter. Sales orders 105 before the date 220 may be plotted in the first area 210 of graphical display 200.

A second area 215 may display both future sales orders 105 as well as an opportunity pipeline that may be separated in accordance to confidence levels 100.1-100.N, designated predictive levels for future sales opportunities. In an embodiment, the second area 215 may depict sales opportunities after a designated week or time date 220 which may be selectably controlled by a user.

Graphical display 200 may also display a target line 190. This target line 190 may represent a specific targeted goal for sales orders by the conclusion of a particular period. Target line 190 may be displayed concurrently in graphical display 200 with the sales orders 105 and the opportunity pipeline 100.1-100.N.

A user may selectably click on buttons 280, 282, and 284 to control the information that is to be displayed in graphical display 200. These buttons may be displayed adjacent to each other and may be situated above graphical display 200. Clickable button 280 may correspond to a selection for the display of expected values for opportunity pipeline for sales order. Clickable button 282 may correspond to a selection for the display of weighted values of the opportunity pipeline for sales orders to be displayed in graphical display 200.

Clickable button 284 may be selected to display previous years' sales data to graphical display 200 to allow for a comparison to historical data over the same time period. A selection of clickable button 284 may display a graph of the previous years sales orders in graphical display 200 simultaneously with and adjacent to the current sales orders and the opportunity pipeline. Graphical display 200 may also display the target sales line for the previously displayed year.

The sales forecasting application 20 may apply the resulting confidence level segmentation to the opportunity pipeline in graphical display 200. Each opportunity in the opportunity pipeline may be assigned to a related business segment from an analysis of historical sales data. As each business segment may be previously assigned to a predictive confidence level as depicted in the embodiment illustrated in FIG. 3, each of the opportunities in the opportunity pipeline may therefore be assigned to a confidence level.

The layered confidence levels of the opportunity pipeline may be depicted in graphical display 200. These layers of confidence levels provide an end user with information directly addressing the reliability of a possible opportunity turning into a sale. The confidence level segmentation displayed in FIG. 4 may allow for an end user to ascertain how an opportunity pipeline is distributed across the different influencing attributes.

Opportunities in successful segments may justify a higher confidence, which may be visually depicted in area 100.1 in graphical display 200. This area may correspond to opportunities that may be designated to a high confidence level. An opportunity that may be designated as a medium confidence level opportunity may be displayed in area 100.2 in graphical display 200. Similarly, an opportunity that may be designated as a low confidence level opportunity may be displayed in area 100.N in the graphical display 200. In another embodiment, where more confidence levels are designated by the end user, the opportunity pipeline may be separated into additional confidence levels.

In an embodiment, the sales forecasting application 20 may be configured with a number of rules or parameters that may alternately assign confidence levels through additional methods, if assigning the opportunity data to historical business segments is inappropriate in particular instances. In an embodiment, these parameters may override the designated confidence levels of the assigned business segments. In an embodiment, opportunities which are close to be being committed, and thus turning into sales orders, may be assigned to a high confidence level regardless of the business segment they may be assigned to. The end user may define a threshold for the chance of success for an opportunity. If an opportunity meets this user defined threshold, the opportunity may be assignment to the highest confidence level, regardless of the business segment the opportunity may be assigned to.

In an embodiment, a user may also define a minimum number of sales necessary to have occurred within a business segment for the confidence level of the business segment to be assigned to an opportunity. For example, in an embodiment where a business segment may be determined to be a high confidence level segment but only a limited number of sales have occurred within the business segment, the system may choose to override an assigned confidence level. In an embodiment, a user may define a threshold number of sales necessary in order for a business segment to be utilized for confidence prediction. If the system does not have sufficient history data for a business segment, the confidence level may be not be accurate depiction of the opportunity. New business segments or business segments without historical data may be assigned manually to a desired confidence level.

The sales forecasting application 20 may be configured to allow for the modification of the opportunity pipeline. The application 20 may allow for the viewing of the individual opportunities in the viewing pane of user interface 25. An end user may modify or adapt an underlying opportunity in regards to value and chance of success. Any such modification may change an assigned confidence level for the opportunity. The confidence level categories may also be manually edited to include or exclude specific opportunities.

The opportunity pipeline displayed in graphical display 200 may correspond to previously selected influencing attributes in selection field 235 in panel 230. Selection of other influencing attributes in selection field 235 may filter the opportunity according to different influencing attributes and generate a corresponding display. A selection of other influencing attributes in selection field 235 may change the opportunity pipeline displayed in graphical display 200. Any changes made via panels 230-270 may be reflected in the pipeline simulation.

In panel 240 may select a particular week to focus on in the opportunity pipeline. A selection of a particular week may be made from selection field 245. A user may also select, for example, “All Weeks” if the user wishes to not focus on a particular week but to view the entire time period in graphical display 200. In an embodiment, a selection from selection field 245 may change the designated date 220, which may represent the current date or a date in which a user may wish to focus on.

Panel 250 may present the list of all confidence levels in selection field 255. In the embodiment of FIG. 4, where a user has previously designated three confidence levels, the confidence levels “low”, “medium”, and “high” may be displayed in selection field. In other embodiments in which more or less confidence levels may be chosen, selection field 255 may display the corresponding number of confidence levels.

A user may select a confidence level in selection field 255 to specifically view opportunity data pertaining to that confidence level in graphical display 200. For example, where a user selects “low” in selection field 255, opportunity area 100.N of the opportunity pipeline may be displayed in graphical display 200. If a user select “medium” in selection field 255, opportunity area 100.2 of the opportunity pipeline may be displayed in graphical display 200. If a user selects “high” in selection field 255, opportunity area 100.1 of the opportunity pipeline may be displayed in graphical display 200. In an embodiment, a user may select multiple confidence levels to display the corresponding opportunity areas in graphical display 200. In an embodiment, if no confidence levels are selected in selection field 255, graphical display 200 may by default, display all of the confidence areas 100.1-100.N of the opportunity pipeline in graphical display 200, as illustrated in FIG. 4.

Panel 260 may list a further limiting value of a first selected influencing attribute. For example, where “Country” is a selected influencing attribute in selection field 235, panel 260 may display a plurality of values that correspond to countries in selection field 265. A user may select a specific country in selection field 265 to limit the sales data and the opportunity data in the opportunity pipeline to that specific country. In an embodiment, the further limiting values in panel 260 may correspond to another selected influencing attribute, such as, for example, “Industry”, “Length of Relationship”, “Number of Changes, “ABC Classification”, etc.

Panel 270 may list a further limiting value of a second selected influencing attribute. For example, where “Length of Relationship” is a second selected influencing attribute in selection field 235, panel 270 may display a plurality of values that correspond to a period of a relationship in selection field 275. A user may select, for example, the number of sales quarters a specific customer has been a customer in selection field 275, as illustrated in FIG. 4, to limit the sales data and the opportunity data in the opportunity pipeline to that specific length of relationship. In an embodiment, the further limiting values in panel 270 may correspond to another selected influencing attribute, such as, for example, “Country”, Industry”, “Number of Changes, “ABC Classification”, etc.

Clickable button 290 may be selected to view and modify the confidence segmentations of the business segments, as illustrated in FIG. 3. A user may click button 290 to modify the confidence levels that may have been used to assign opportunity areas 100.1-100.N of the opportunity pipeline in graphical display 200. Clickable button 295 may be selected to further analyze the sales history.

An end user may use the simulation of the opportunity pipeline broken down into confidence levels, to make informed decision about which opportunities, for example, will be included in a sales forecast to achieve any sales targets. As a result, trends from historical sales may be applied to a current pipeline and an end user may have a systematic and proven perspective on the reliability of their pipeline. This may allow the end user to derive step by step, a forecast having a good understanding of reliability for the underlying opportunity data.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the embodiments of the present invention may be implemented in hardware, software, firmware, or a combination thereof and utilized in systems, subsystems, components or subcomponents thereof. When implemented in software, the elements of the invention are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A method for providing predictive confidence determination for sales forecasts, the method comprising:
identifying business segments correlated to at least one selected influencing attribute;
assigning a confidence level to each of the business segments, wherein the confidence levels are divided by boundary values between each of the confidence levels that are selectably controlled;
mapping each opportunity from opportunity data retrieved from an in-memory database to one of the business segments;
assigning the confidence level of the selected business segment to the corresponding opportunity; and
displaying an opportunity pipeline in a user interface of a user terminal, the opportunity pipeline being separated into the confidence levels for the opportunities.

2. The method according to claim 1, further comprising:
selecting at least one influencing attribute based on historical data retrieved from the in-memory database.

3. The method according to claim 1, further comprising:
sorting the business segments in descending order based on the assigned confidence level.

4. The method according to claim 1, further comprising:
evaluating the business segments to identify a trend.

5. The method according to claim 4, further comprising:
extrapolating any identified trends to predict outcomes for a key statistic for the business segments.

6. The method according to claim 5, wherein the predicted outcomes are used to assign confidence levels to each of the business segments.

7. The method according to claim 1, wherein a number of confidence levels is designated.

8. The method according to claim 5, wherein the key statistic is sales revenue.

9. The method according to claim 6, wherein business segments having predicted outcomes greater than a first boundary value are determined as having a high confidence level.

10. The method according to claim 9, wherein business segments having predicted outcomes lower than a second boundary value are determined as having a low confidence level.

11. The method according to claim 10, wherein business segments having predicted outcomes between the first and the second boundary values are determined as having a medium confidence level.

12. The method according to claim 1, wherein each opportunity is mapped to one of the business segments as a function of the historical data retrieved from the in-memory database.

13. A forecasting system for providing predictive confidence determination for sales forecasts, the system comprising:
at least one user terminal displaying a user interface, the sales forecasting system displayed on the user interface;
an in-memory database storing historical data and opportunity data; and
a processor operable to:
identify business segments correlated to at least one selected influencing attribute;
assign a confidence level to each of the business segments, wherein the confidence levels are divided by boundary values between each of the confidence levels that are selectably controlled;
map each opportunity from the opportunity data retrieved to one of the business segments;
assign the confidence level of the selected business segment to the corresponding opportunity; and
display an opportunity pipeline in a user interface of a user terminal, the opportunity pipeline being separated into the confidence levels for the opportunities.

14. The system according to claim 13, further comprising:
an advanced business application programming (ABAP) system to access the stored historical and opportunity data from the in-memory database.

15. The system according to claim 13, wherein the sales forecasting system is implemented on an integrated business platform.

16. The system according to claim 13, wherein the processor sorts the business segments in descending order based on the assigned confidence level.

17. The system according to claim 13, wherein the processor evaluates the business segments to identify any trends and extrapolates any identified trends to predict outcomes for a key statistic for the business segments, the predicted outcomes being used to assign confidence levels to each of the business segments,

18. The system according to claim 13, wherein business segments having predicted outcomes greater than a first boundary value are determined as having a high confidence level, business segments having predicted outcomes lower than a second boundary value are determined as having a low confidence level, and business segments having predicted outcomes between the first and the second boundary values are determined as having a medium confidence level.

19. A forecasting system for providing predictive confidence determination for sales forecasts, the system comprising:
at least one user terminal;
an in-memory database storing historical data and opportunity data;
an advanced business application programming (ABAP) system to access the stored historical and opportunity data from the in-memory database;
an application displayed on a user interface of the user terminal, the application configured to:
select at least one influencing attribute based on the historical data retrieved from the in-memory database;
identify business segments correlated to the at least one influencing attribute;
evaluate the business segments to identify a trend;
extrapolate any identified trends to predict outcomes for sales revenue for the business segments;
assign a confidence level to each of the business segments based on the predicted outcomes for sales revenue, wherein the confidence levels are divided by boundary values between each of the confidence levels that are selectably controlled;
sort the business segments in descending order based on the assigned confidence level;
map each opportunity from the opportunity data retrieved to one of the business segments as a function of the historical data retrieved from the in-memory database;
assign the confidence level of the selected business segment to the corresponding opportunity; and
display an opportunity pipeline in a user interface of the user terminal, the opportunity pipeline being separated into the confidence levels for the opportunities.

20. A method for providing predictive confidence determination for sales forecasts, the method comprising:
selecting at least one influencing attribute based on historical data retrieved from an in-memory database;
identifying business segments correlated to the at least one influencing attribute;
evaluating the business segments to identify a trend;
extrapolating any identified trends to predict outcomes for sales revenue for the business segments;
assigning a confidence level to each of the business segments based on the predicted outcomes for sales revenue, wherein the confidence levels are divided by boundary values between each of the confidence levels that are selectably controlled;
sorting the business segments in descending order based on the assigned confidence level;
mapping each opportunity from the opportunity data retrieved to one of the business segments as a function of the historical data retrieved from the in-memory database;
assigning the confidence level of the selected business segment to the corresponding opportunity; and
displaying an opportunity pipeline in a user interface of the user terminal, the opportunity pipeline being separated into the confidence levels for the opportunities.
